(19) United States
(12) Patent Application Publication
(10) Pub. No.: US 2002/0030705 A1
(43) Pub. Date: Mar. 14, 2002

(54) Method for providing angular position information for a radial printing system

(75) Inventors: Carl E. Youngberg, Mapleton, UT (US); George L. Bradshaw, Palo Alto, CA (US); Randy Q. Jones, Sunnyvale, CA (US)

Correspondence Address: BEYER WEAVER & THOMAS LLP, P.O. BOX 778, BERKELEY, CA, 94704-0778, US

(73) Assignee: ELESYS, Inc.

(21) Appl. No.: 09/815,064

(22) Filed: Mar. 21, 2001

Related U.S. Application Data
(60) Provisional application No. 60/191,317, filed on Mar. 21, 2000.

(51) Int. Cl. B41J 3/00

(52) U.S. Cl. 347/2; 347/14; 347/9

(57) ABSTRACT

Disclosed is a method for detecting an angular position of a rotating media having a native wobble signal. Prior to recording data on the rotating media, timing information is obtained from the native wobble signal in the rotating media over a substantial portion of a prerecorded media area of the rotating media. An angular position of the rotating media is determined from the timing information. The determined angular position is used to accurately print an image onto the rotating media.

### CROSS REFERENCE TO RELATED APPLICATIONS

This application claims priority to U.S. Provisional Patent Application, having application No. 60/191,317 (Attorney Docket No. ELESP002P), filed Mar. 21, 2000, entitled “A Method for Providing Angular Position Information for a Radial Printing System” by Carl E. Youngberg, et al, which application is incorporated herein by reference in its entirety for all purposes. This application is also related to co-pending U.S. Patent Application, having application No. 09/062,300 (Attorney Docket No. ELESP001), filed Apr. 17, 1998, entitled “Radial Printing System and Methods” by George L. Bradshaw et al, which application is incorporated herein by reference in its entirety for all purposes.

### REFERENCE MATERIALS

CD Standard Specifications (Orange), The Orange Book, (A set of documents describing the Recordable Compact Disc Systems) Part II, Philips Electronics N.V., http://www.licensing.philips.com/cdsystems/cdstand specorange.html

CD-ROM Professional's CD-Recordable Handbook, Dana J. parker and Robert A. Starrett, 1996, Pemberton Press, Wilton Conn., ISBN 0-910965-18-8

The Compact Disk Handbook, 2^{nd} Edition, Ken C. Pohlmann, 1992, A-R Editions, Madison, Wis., ISBN 0-89579-300-8

### SUMMARY OF THE INVENTION

The present invention relates to information circular recording media, such as an optical disc like CD recordable media (CD-R). For the scope of this invention, the terms “CD-R” and “CD” are intended to mean all varieties of recordable media (e.g., CD and DVD).

More particularly, this invention uses a variety of methods to determine the instantaneous angular position of a spinning and typically circular recordable CD-R media to enable radial printing. This includes: using prerecorded timing information from the native wobble signal in pregrooved CD-R recordable disc media over the entire prerecorded disc area; using the timing-code information in the data track of an already recorded CD-R disc; or using an entirely independent encoding pattern pre-placed during manufacturing directly on the inner hub or outer circumference edge of the CD-R media coupled with an external encoder sensor. These signals are uniquely combined with a radial printing system to form a synchronized system for printing a label on the top surface of the recordable disc media while the disc is spinning, independent of recording, during recording or during playback.

The CD Standard Specifications Orange Book specifies in detail how CD-R media are to be pregrooved for use, which is well known in to those skilled in the art. Timing markings along a pre-grooved spiral track contains a wobble signal. This wobble signal provides CD laser head servo tracking alignment and clocking information to control disc spin rate. The native wobble is present throughout the prerecorded CD-R disc media, including the prerecorded track in the Power Calibration Area (PCA), the Program Memory Area (PDA), lead-in, data programming, or lead out areas. Alternately this invention uses the timing-code information in the post-recorded data area of the CD-R media.

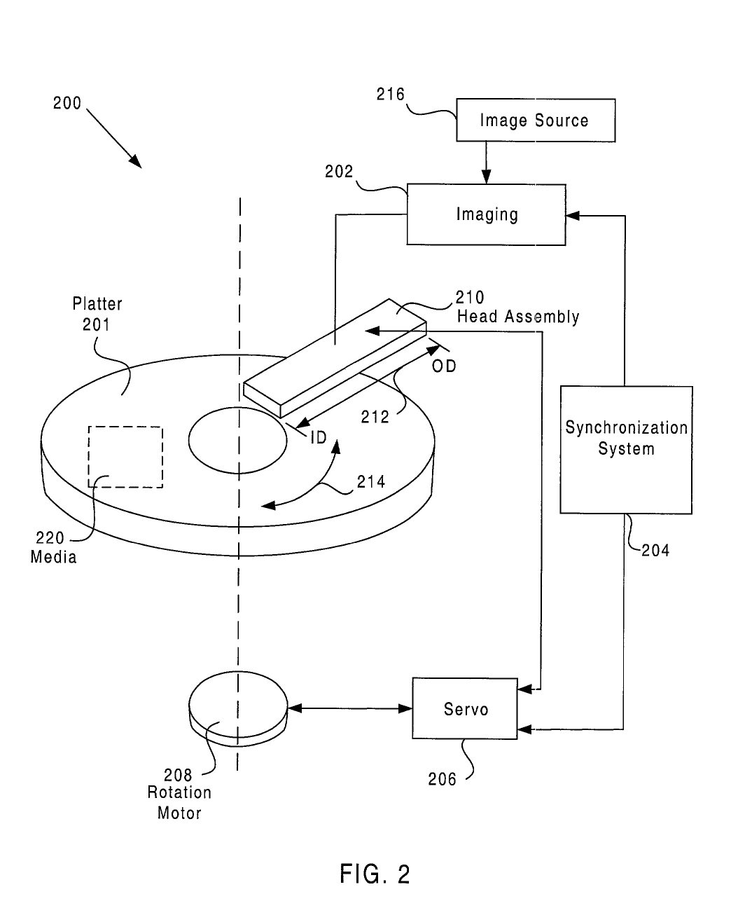

The present invention uses several methods for sensing the angular position of rotating or spinning CD-R media to be utilized in a radial printing system. FIG. 2 is a diagrammatic representation of an example radial printing system in which the present invention may be implemented. As shown, the printing head assembly 210 is placed radially over the spinning CD disc 214. The synchronization system 204 uses signals from the CD servo 206 to sense the disc 220 (platter 201) spin rate or control the motor 208. Several embodiments of a radial printing system are described in the above referenced co-pending U.S. Patent Application by Bradshaw et al, which is incorporated by reference. Radial printing can be optionally performed on spinning media, even while actual CD recording is in process. As such, a radial printing system preferably determines the instantaneous angular velocity and position of rotating CD-R media to be able to print radially.

The present invention uses these signals on CD-R media in a unique way to provide angular position information for radially printing a label on the top surface of the CD-R media while it spins.

### BEST MODE FOR CARRYING OUT THE INVENTION

To determine the instantaneous angular velocity and rate of disc spin specifically for radial printing, the radial printing system synchronizes with the spinning disc media and/or the CD-R device control system. To do this, this invention uniquely uses signals from among the following: (1) the inherent pregrooved wobble frequency signal in the unrecorded track of a new CD-R disc, (2) the timing-code information in the data track of an already recorded CD-R disc, or (3) an entirely independent encoding pattern pre-placed during manufacturing directly on the inner hub or outer circumference edge of the CD-R media.

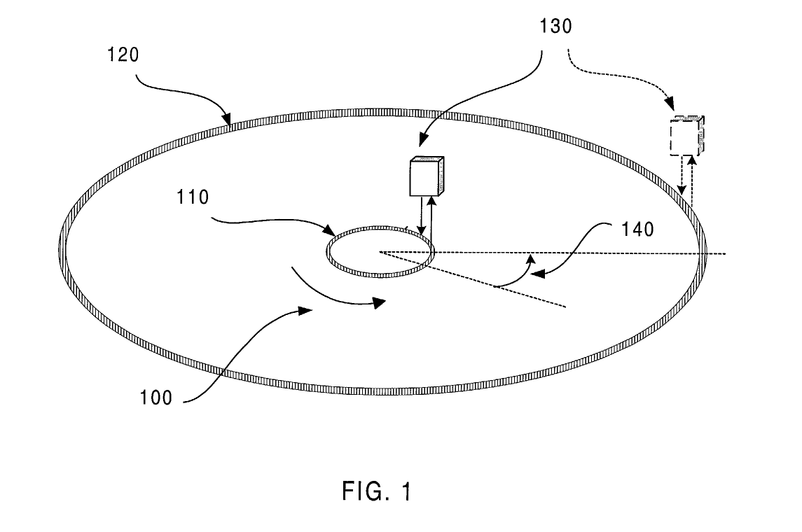

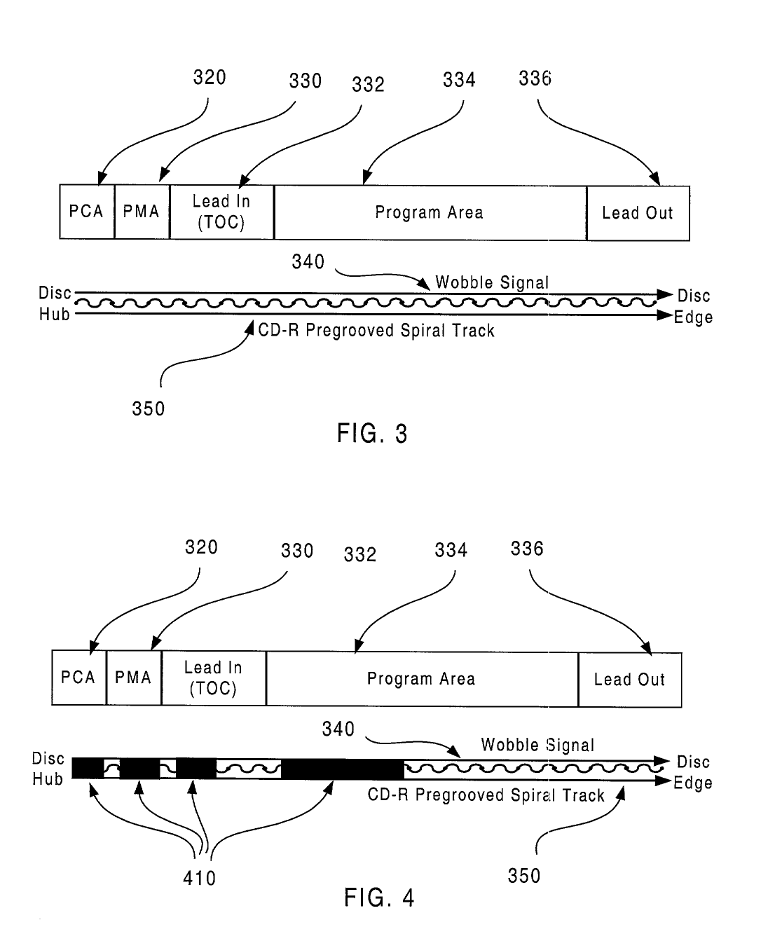

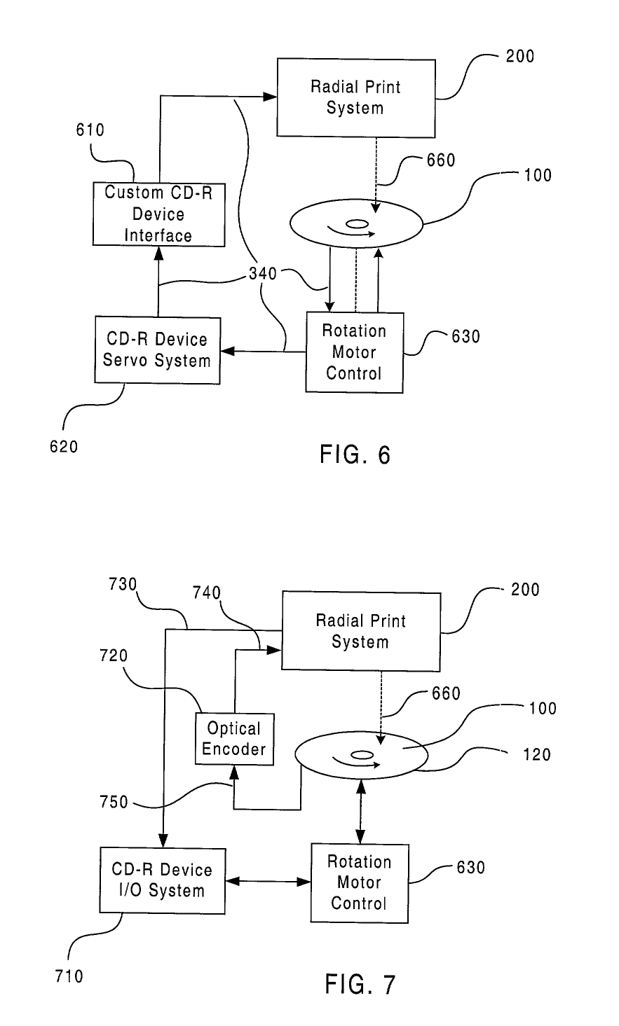

In the first embodiment, the present invention uses the pre-groove spiral track 350 wobble frequency signal 340 illustrated in FIG. 3 inherent in all CD-R recordable media to determine the instantaneous angular position 140 of a spinning circular media 100 shown in FIG. 1, to enable precise placement of ink in the application of radial printing shown in FIG. 2, such as with an ink jet print head 210. While this signal 340 is used primarily for alignment and tracking of the CD-R laser for reading and recording shown in FIG. 6, 620, it can also be used to determine the angular position 140 (FIG. 1) of the spinning media at any given time during rotation and thus provide a high degree of printing accuracy. Since these timing signals are only available while the CD-R media is spinning, preferably they are carefully synchronized with the CD writer device control system. For example, the CD-R recording software is preferably tightly coupled and synchronized with the software that controls the printing to ensure that the printing process proceeds without interfering with the recording process. Likewise, since the CD motor 630 must be spun an adequate number of revolutions to complete the printing process, it may be necessary to activate the CD-R motor 630 to finish the printing task. The advantage of this method is to provide accurate angular print information without the need for additional components, such as an eternal encoder and codewheel, since it uses standard CD-R media for all timing information. For example, an all-in-one device to record discs and print labels on encoder-pattern-grating CD/DVD media may be designed for lower overall manufacturing cost or allow smaller size of the device, because an external encoder or grating is unnecessary.

In a second embodiment, similar to the first, the same considerations are necessary for printing on CD-R media; however, the disc media may contain partially completed recording information. This is illustrated in FIG. 4 in contrast to FIG. 3. In FIG. 4, the timing signals used to determine the angular position 140 of the spinning media 100 are derived instead from or a combination of the timing-code information in the data track 410 of an already- or partially recorded CD-R disc. In the later case of a partially recorded disc, such as a Multisession disc, the timing information 410 is derived by combining timing-code information in the data track of the already recorded area, on the one hand, with the pre-groove wobble frequency signal 340 inherent in remaining unrecorded media, on the other hand; these are used in concert to determine the instantaneous angular position 140 of a spinning circular media 100. Similar to the first method, the advantage of this method is to provide accurate angular print information without the need for additional components since it uses standard CD-R media for all timing information.

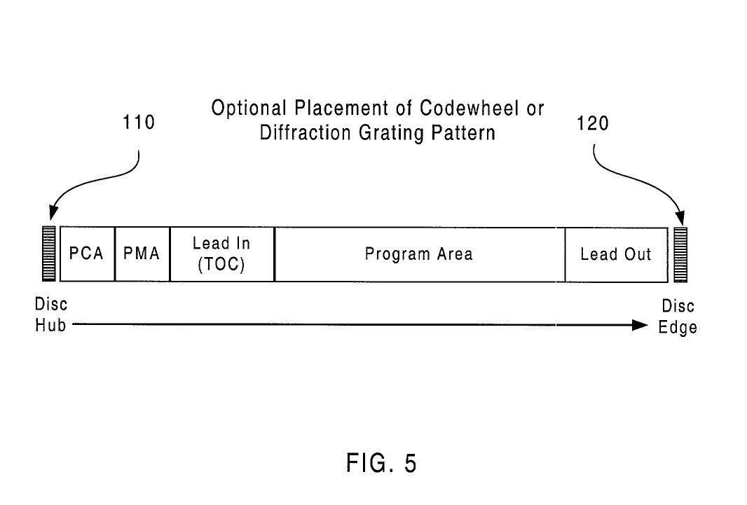

In a third embodiment, illustrated in FIG. 1 and in the block diagram in FIG. 7, the recordable CD media is manufactured with a unique design to include an explicit encoder pattern or grating directly on the inner hub 110 or outer 120 circumference edge of the media, similar to the functions of a traditional encoder wheel. The grating pattern 110 or 120 is positioned just prior to or after the preformatted CD-R data area as shown in FIG. 5 herein. In the application for a radial printing system (FIG. 2), an encoder sensor 130 is positioned over the respective inner 110 or outer 120 track to count and measure the angular position. Given adequate angular resolution 140, this information is used to precisely place printed material 660 onto the spinning disc media 100, independent of the disc spin rate. This method has the advantage of providing encoder positional information without the need for a separate, external encoder wheel or grating pattern, since it is already included in the CD-R media during manufacturing. It also has the advantage of providing necessary angular print information completely independent of and decoupled from the normal operations of the CD recording system. Since it automatically and independently senses the spin rate from the signal 750 and 740, the radial printing system only needs to command the CD motor 630 to spin an adequate number of revolutions to complete printing, should the CD recording or reading process complete prior to completing radial printing. This simplifies the device, since the CD motor 630 can be enabled through its standard interface 730 via software control rather than a custom hardware interface 610. Illustrations in FIG. 1, FIG. 5, and FIG. 7 show the potential locations for the encoder pattern according to this method, near either the inner hub or outer circumference, either on the bottom side or on the top side of the media. However, other placements, methods and embodiments for encoder patterns directly on CD-R media may be devised as the technology and evolving CD or circular media standards permit.

A zero synchronization mark widely known to and used by those skilled in the art is included in the encoder pattern 110/120 to reset the count with each rotation. A benefit of this new method is that it re-synchronizes the label position on a CD-RW media when reinserted. This method enables removing and later reinserting the media multiple times to include additional printed content to the top surface of the media, or in the case of rewritable media (CD-RW/DVD-RW) this would allow adding new printed label information as new data is rewritten to the media, without the need for recognizing a previously printed label pattern, as in the prior art Cutler, et al. For example, one application is adding new picture files to previously recorded CD-RW (rewritable) media; the original disc label was prepared and saved as a template; upon reinsertion, the user updates the label template adding extra label or identification to the CD and then prints it again with prefect registration.

In summary, this third embodiment shows how to include an optical or diffraction grating pattern directly on blank circular media, negating the need to add an external encoder grating pattern and enabling the new technology to be able to re-synchronize the label position on a CD when re-inserted.

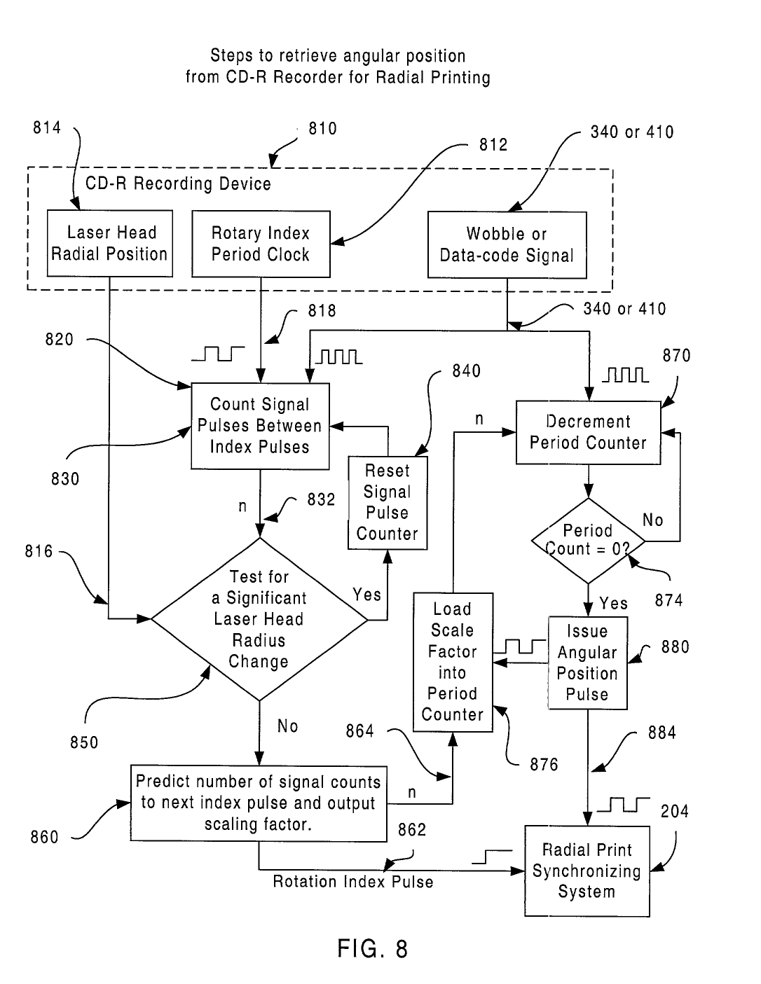

The angular position 140 is derived from normal signals in the CD-R recording system. Referring to FIG. 8, three types of signals provide enough information with a sufficient accuracy and precision to determine angular position and thus enable radial printing: the wobble 340 or data-code 410 signals, the laser head radial position 816, and a rotary index period clock pulse 818. The latter, rotary index period clock pulse, can be generated in several ways, such as: a signal on the CD-R drive control system, the CD-R stepper motor pole positions, and external reference clock (separate component), or an external optical sensor determining the CD rotation (separate component). We anticipate other methods to acquire or fashion this rotary index period clock pulse; however, in general, this signal must be present to modulate the wobble or data-code signal.

In FIG. 8, the rotary index period pulses 818 may occur one or more times per revolution and at irregular positions; but for a given CD-R drive type, they will be at fixed and repeatable angular positions 140. The rotation index pulse 862 is derived from the rotary index period pulses 818 in such a way that only one pulse per revolution occurs.

The signal pulse counter 820 uses either the data-code signal pulses 410, or the wobble pulses 340, to determine the number of signal pulses 340/410 between the index pulses 818. Given the fixed relationship between angular position 140 of index pulses 818 and the current signal pulse count 340/410, a prediction is made for the number of signal pulses 340/410 that will occur per angular position 140 in the next region between index pulses. The prediction is converted into a scale factor 864 by dividing it by the number of angular positions per index region, based upon the geometry of the index pulses 140.

The number of signal pulses 340/410 between indexes cannot change significantly in order to accurately predict the scale factor 864. However, if the laser radial position 816 is repositioned differently from the current helical writing or reading track 350 by the CD-R system, a more gross correction is required to generate accurate angular position 140 for the radial printing system. In this case, the signal pulse counter 840 must be recalibrated by clearing and recounting until the count 832 is stable.

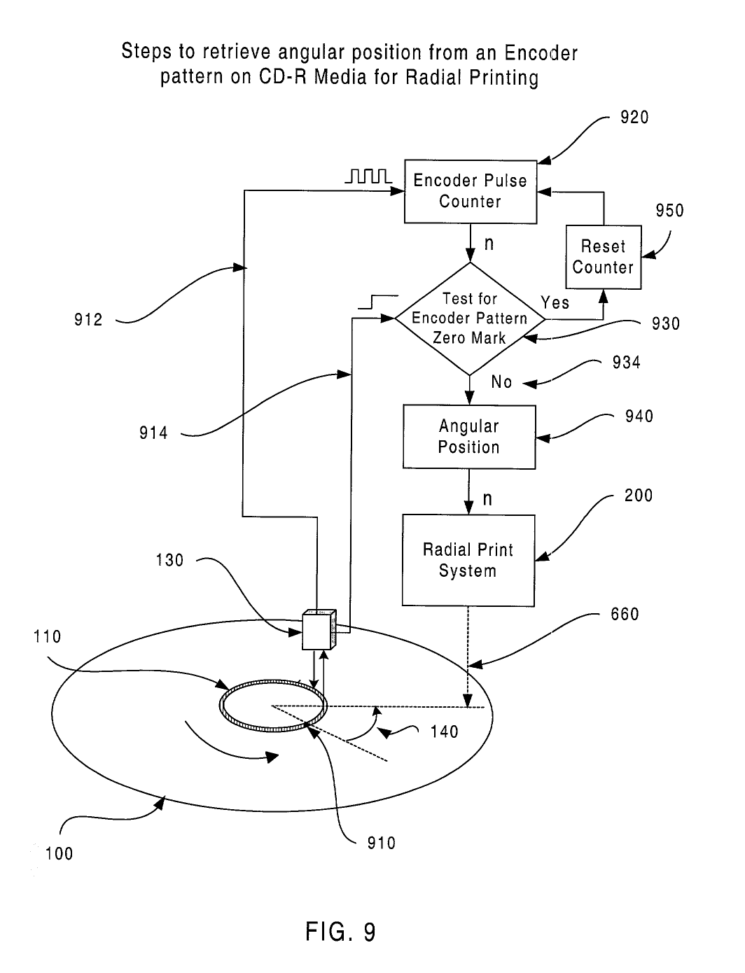

Once the scale factor 864 is computed, it is used in a self-resetting period counter 870 to count down the number of signals per angular position 140. When the count reaches zero, the next rotationally sequenced angular position is been reached, and a signal equivalent to the encoder pulse FIG. 9, 912, is generated. The radial print synchronizing system 204 generates the angular position pulse 140 by counting angular position pulses 884 and then

We claim:

1. A method for detecting an angular position of a rotating media having a native wobble signal, comprising:
prior to recording data on the rotating media, obtaining timing information from the native wobble signal in the rotating media over a substantial portion of a prerecorded media area of the rotating media;
determining an angular position of the rotating media from the timing information; and
using the determined angular position to accurately print an image onto the rotating media.

2. A method for detecting an angular position of a rotating pre-recorded media that has timing code information associated with a data track thereon, the method comprising:
obtaining the timing code information associated with the data track of the rotating pre-recorded media;
determining an angular position of the rotating pre-recorded media from the obtained timing code information; and
using the determined angular position to accurately print an image onto the rotating pre-recorded media.

3. A method for detecting an angular position of a rotating media having an encoding pattern pre-placed during manufacturing of such media directly on an inner hub or an outer circumference edge of the rotating media, the method comprising:
obtaining the encoding pattern from the rotating media;
determining an angular position of the rotating media from the encoding pattern; and
using the determined angular position to accurately print an image onto the rotating media.
